(19) United States
(12) Patent Application Publication
(10) Pub. No.: US 2023/0340227 A1
(43) Pub. Date: Oct. 26, 2023

(54) COMPOSITION CONTAINING AMMONIUM POLYPHOSHATE

(71) Applicant: Chemische Fabrik Budenheim KG, Budenheim (DE)

(72) Inventors: Bors Cajus ABELE, Buskow (DE); Christian DIPPEL, Wiesbaden (DE); Birgit FAßBENDER, Mainz (DE); Sebastian FEIDNER, Münsterappel (DE); Thomas FUTTERER, Ingelheim (DE); David Garcia MARTINEZ, Zaragoza (ES); Christian LITTERSCHEID, Ober-Olm (DE); Siegfried MENGEL, Frei-Laubersheim (DE); Sebastian MOSCHEL, Groß-Gerau (DE); Heiko ROCHHOLZ, Rümmelsheim (DE); Mikel SCHÖLLER, Bingen (DE); Rüdiger WISSEMBORSKI, Neuruppin (DE)

(73) Assignee: Chemische Fabrik Budenheim KG, Budenheim (DE)

(21) Appl. No.: 18/024,927

(22) PCT Filed: Sep. 16, 2021
(86) PCT No.: PCT/EP2021/075531

§ 371 Date: Mar. 6, 2023

(30) Foreign Application Priority Data
Sep. 17, 2020 (DE) 10 2020 124 334.0

(51) Int. Cl. C08K 3/32; C09K 21/04

(52) U.S. Cl. CPC C08K 3/32; C09K 21/04; C08K 2003/323; C08K 2003/324

(57) ABSTRACT

A composition containing ammonium polyphosphate and at least one alkali metal salt or alkaline-earth metal salt are provided along with a process for preparing the composition and uses of the composition as a flame retardant and/or coating material.

### SUBJECT-MATTER OF THE INVENTION

The present invention relates to a composition comprising ammonium polyphosphate and at least one alkaline metal salt or alkaline earth metal salt, a method for producing this composition, and the use of this composition as a flame retardant and/or coating material.

### BACKGROUND OF THE INVENTION

The use of ammonium polyphosphate as a halogen-free flame-retardant additive in flame-retardant compositions has been known for a long time. The flame retarding quality is produced by the generation of an intumescent layer, as described in DE 19 517 499 A1. The publication also discloses the production of ammonium polyphosphate starting from P₂O₅ and ammonium orthophosphate in a NH₃ atmosphere.

U.S. Pat. No. 2,010,298 474 A1 relates to flame-retardant compositions comprising an ammonium polyphosphate, a 1,3,5 triazine derivative, a zinc or aluminium phosphate compound, and a melamine foaming agent. The halogen-free flame retardant can be used in a polymer matrix.

However, the long-chain ammonium polyphosphates, in particular, have only a low water solubility. This restricts the application range of the above-named compositions, for example, because they cannot be used in water-based coatings and varnishes. In addition, ammonium polyphosphate has a high opacity due to its crystalline structure, so that corresponding compositions often have turbidity that is recognisable even to the naked eye. This also restricts the application range of compositions with ammonium polyphosphates. In addition, the decomposition temperature of ammonium polyphosphates is regularly >240° C., whereas the decomposition of some technically important plastics such as polymethyl methacrylate or polyvinyl chloride starts already at 170° C. or 200° C. As a result, with ammonium polyphosphate, only a low flame-retardant effect can be achieved when applied in these plastics.

### Task

In light of the foregoing, the task addressed by the invention was to provide a composition comprising ammonium polyphosphate and having a higher water solubility, similar or even better flame-retardant properties, and a higher transparency than the compositions known in the prior art with a comparable content of ammonium polyphosphate.

### DESCRIPTION OF THE INVENTION

According to the present invention, this task is solved by a composition comprising
A) ammonium polyphosphate, and
B) a salt or combination of salts selected from the group consisting of alkali metal salts and alkaline earth metal salts, preferably selected from among alkali metal salts,
   wherein the weight ratio of the weight of A) to the weight of B), i.e. the weight of the salt or the summed weights of the combination of salts, in the composition is in the range of 20:1 to 1:1, preferably 10:1 to 2:1, more preferably 8:1 to 2:1, even more preferably 5:1 to 2:1, and most preferably 4:1 to 2:1.

In a preferred embodiment of the invention, the composition comprises only one salt selected from the group consisting of alkali metal salts and alkaline earth metal salts, wherein the weight ratio of the weight of the ammonium polyphosphate to the weight of the one alkali metal salt or alkaline earth metal salt in the composition ranges from 20:1 to 1:1, preferably from 10:1 to 2:1, more preferably from 8:1 to 2:1, even more preferably from 5:1 to 2:1, and most preferably from 4:1 to 2:1.

In a further preferred embodiment of the invention, the composition comprises several salts, selected from the group consisting of alkali metal salts and alkaline earth metal salts, wherein the weight ratio of the weight of the ammonium polyphosphate to the summed weight of the several salts selected from the group consisting of alkali metal salts and alkaline earth metal salts in the composition is in the range of 20:1 to 1:1, preferably 10:1 to 2:1, more preferably 8:1 to 2:1, even more preferably 5:1 to 2:1, and most preferably 4:1 to 2:1.

The combination according to the invention of ammonium polyphosphate and salt or combination of salts selected from the group consisting of alkali metal salts and alkaline earth metal salts results in a significant increase in water solubility and transparency of the composition. In addition, the decomposition temperature of the ammonium polyphosphate contained in the composition is also decreased. As a result, the application range of flame-retardant compositions containing ammonium polyphosphate can be significantly extended.

Without being bound by this theory, the inventors assume that the salt or combination of salts selected from the group consisting of alkali metal salts and alkaline earth metal salts at least partially breaks down the crystalline structure of the ammonium polyphosphate through complexation via the at least one alkali metal ion or alkaline earth metal ion, thereby creating larger amorphous regions. Because the crystalline regions of the polymer cause light refraction, the transparency is increased by the addition of alkali metal salts and/or alkaline earth metal salts. The water solubility and the decomposition temperature are also determined substantially from the degree of crystallinity of the polymer and are therefore positively influenced by the addition of alkali metal salts and/or alkaline earth metal salts as described above.

In a preferred embodiment of the invention, the water solubility of the composition at 25° C. is at least 10 g/L, preferably 50 g/L, more preferably 100 g/L, even more preferably 200 g/L, and most preferably 250 g/L.

In a preferred embodiment of the invention, the proportion of the sum of the masses of ammonium polyphosphate and the salt or the combination of salts selected from the group consisting of alkali metal salts and alkaline earth metal salts is ≥50 wt. %, preferably ≥70 wt. %, more preferably ≥80 wt. %, and most preferably ≥90 wt. %. In a preferred embodiment, the composition consists of ammonium polyphosphate and a salt or combination of salts selected from the group consisting of alkali metal salts and alkaline earth metal salts.

In a preferred embodiment, the proportion of ammonium polyphosphate in the total mass of the composition is ≥40 wt. %, preferably ≥50 wt. %, more preferably ≥60 wt. %, and most preferably ≥75 wt. %.

In a preferred embodiment, the proportion of salt or combination of salts selected from the group consisting of alkali metal salts and alkaline earth metal salts is ≥20% by weight, preferably ≥30% by weight, more preferably ≥40% by weight, and most preferably ≥50% by weight.

The stated weight fractions and ratios as well as the total mass of the composition always refer to the dry weight, i.e. the weight after drying at 100° C. until a constant mass is achieved, wherein “constant” means that the weight difference per minute of drying at 100° C. is <0.5 wt. %, preferably <0.2 wt. %.

The positive effects described above are particularly pronounced when the alkali metal salts and alkaline earth metal salts, from which the salt or combination of salts are selected, are phosphates. The inventors assume that alkali metal phosphates or alkaline earth metal phosphates can interact particularly well with ammonium polyphosphate due to their similar basic structure and thereby break up their crystalline structures.

In a preferred embodiment of the invention, the alkali metal salts and alkaline earth metal salts from which the salt or combination of salts are selected are therefore phosphates, preferably oligo-, meta-, pyro- or polyphosphates. Particularly preferred are oligo-, pyro- or polyphosphates.

Oligo- or polyphosphates of low chain length are particularly suitable. The inventors assume that they can penetrate very well into the crystalline structure of the ammonium polyphosphate and break it up due to their smaller size compared to the longer chain analogues. However, for a particularly pronounced effect according to the invention, the inventors also observed that the chain length of the oligo- or polyphosphates should not be too short. The inventors attribute this to the increased complex formation capacity of oligo- and polyphosphates at higher chain length. In a preferred embodiment of the invention, the alkali metal salts and alkaline earth metal salts from which the salt or combination of salts are selected are therefore oligo- or polyphosphates, wherein the number-average degree of polymerization of the oligo- or polyphosphates is at least 2, preferably at least 3, more preferably at least 5, and most preferably at least 10, but not more than 200, preferably not more than 100.

In a preferred embodiment, the number-average degree of polymerization of the oligo- or polyphosphates is in the range of 2 to 200, preferably 2 to 100, more preferably 3 to 100, and most preferably 5 to 100.

The alkali metal salts and alkaline earth metal salts from which the salt or combination of salts are selected can also be organic alkali metal salts and alkaline earth metal salts. This is associated with the advantage that they generally burn without residues except for the metal content. This can be conducive to certain flame-retardant applications.

In a preferred embodiment of the invention, the alkali metal salts and alkaline earth metal salts from which the salt or the combination of salts is selected are organic alkali metal salts and alkaline earth metal salts, preferably selected from the class of compounds consisting of carbonates, oxalates, terephthalates, isophthalates, formates, fumarates, tartrates, maleates, phenolates, benzoates, acetates, citrates, succinates, lactates, glycolates and mixtures of the foregoing type.

The one or more alkali metal salts or alkaline earth metal salts can comprise one or more alkali metal ions and/or alkaline earth metal ions, depending on the structure. The effects according to the invention are particularly pronounced when at least one metal ion of the alkali metal ions or alkaline earth metal ions of the alkali metal salts and alkaline earth metal salts is Na or K, preferably Na. Particularly preferably, all metal ions of the alkali metal ions or alkaline earth metal ions of one or all of the selected alkali metal salts and alkaline earth metal salts are Na and/or K, preferably Na. The inventors assume that Na or K are particularly well suited to breaking down the crystalline structures of the ammonium polyphosphate through complexation due to their small size. Particularly preferred for all salts of the combination of salts are all metal ions of the alkali metal ions or alkaline earth metal ions Na and/or K.

Because the effects according to the invention are attributable to the interactions of the alkali metal salt(s) or alkaline earth metal salt(s) with ammonium polyphosphate, these interactions are enhanced by increasing the interaction region of alkali metal salt or alkaline earth metal salt with ammonium polyphosphate. Preferably, therefore, the salt or salts of the combination of salts selected from the group consisting of alkali metal salts and alkaline earth metal salts and/or the ammonium polyphosphate have a low particle size. In a preferred embodiment of the invention, the salt or salts of the combination of salts selected from the group consisting of alkali metal salts and alkaline earth metal salts and/or the ammonium polyphosphate have a particle size of ≤100 μm, preferably ≤50 μm, more preferably ≤20 μm, and most preferably ≤10 μm, as determined by light scattering in accordance with DIN-ISO-ISO 13320.

The effects achieved by the addition of a salt or combination of salts selected from the group consisting of alkali metal salts and alkaline earth metal salts to ammonium polyphosphate can be observed even in ammonium polyphosphates of very high chain length, which typically have very low water solubility, moderate transparency, and a high decomposition point. In a preferred embodiment of the invention, the number-average degree of polymerization of the ammonium polyphosphate is therefore ≥100, preferably ≥120, more preferably ≥150, even more preferably ≥200, still more preferably ≥400, even more preferably ≥600, and most preferably ≥900. The number-average degree of polymerization of the ammonium polyphosphate indicates the number of building blocks per polymer molecule and can be determined from the number-average molar mass of the polymer molecule. In the case of ammonium polyphosphate, for example, this can be determined by ³¹P-NMR spectroscopy, size exclusion chromatography (SEC), and/or light scattering.

In the decomposition of flame retardants, halogens contained therein are released as corrosive and harmful gases. Such corrosive combustion gases pose a high risk, in particular in the field of electronics. Because of this, despite the highly flame-retardant effect of halogens, halogen-free flame retardants are now preferred.

Proportions of heavy metals, i.e. metals having a density of >5 g/cm³, must also be avoided out of environmental and health considerations.

In a preferred embodiment of the invention, the composition therefore has a halogen content and/or a content of metals having a density >5 g/cm³ of ≤1.0 wt. %, preferably ≤0.5 wt. %, particularly preferably ≤0.2 wt. %, and most preferably <0.1 wt. %.

The inventors also observed that the effects of the invention are particularly pronounced when the composition has a low water content. Without being bound by this theory, the inventors assume that water promotes the interaction of the salt or a combination of salts selected from the group consisting of alkali metal salts and alkaline earth metal salts with ammonium polyphosphate.

In a preferred embodiment of the invention, the water content of the composition as determined in accordance with DIN EN 20287 is at least 0.1 wt. %, particularly preferably 0.2 wt. %, more preferably at least 0.5 wt. %, and most preferably 1.0 wt. %, but preferably not more than 10 wt. %, particularly preferably not more than 5 wt. %.

Ammonium polyphosphate can be employed advantageously in combination with other flame retardants, e.g., those that cause flame retardation by another mechanism. Due to the interaction of ammonium polyphosphate with other flame retardants, a synergistic effect, i.e. an effect that goes beyond the mere sum of the flame-retardant effect of the individual components, can be achieved.

In a preferred embodiment, the composition thus contains at least one further flame-retardant component, which is preferably selected among nitrogen bases, melamine derivatives, phosphates, pyrophosphates, polyphosphates, organic and inorganic phosphinates, organic and inorganic phosphonates, and derivatives of the aforementioned compounds, preferably selected under ammonium polyphosphate, ammonium polyphosphate particles coated and/or coated and cross-linked with melamine, melamine resin, melamine derivatives, silanes, siloxanes, polysiloxanes, silicones, or polystyrenes, as well as 1,3,5-triazine compounds, including melamine, melam, melem, melon, ammeline, ammelide, 2-ureidomelamine, acetoguanamine, benzoguanamine, diaminephenyl triazine, melamine salts and adducts, melamine cyanurate, melamine borate, melamine orthophosphate, melamine pyrophosphate, dimelamine pyrophosphate, aluminium diethyl phosphinate, melamine polyphosphate, oligomeric and polymeric 1,3,5-triazine compounds, and polyphosphates of 1,3,5-triazine compounds, guanine, piperazine phosphate, piperazine polyphosphate, ethylenediamine phosphate, pentaerythritol, dipentaerythritol, borophosphate, 1,3,5-trihydroxy ethyl isocyanurate, 1,3,5-triglycidyl isocyanurate, triallyl isocyanurate, and derivatives of the aforementioned compounds. In a preferred embodiment, the polymeric material contains waxes, silicones, siloxanes, fats, or mineral oils for better dispersibility of the further flame-retardant component.

The present invention also relates to a polymeric material comprising a polymer and a composition according to the present invention. In order to achieve a sufficient flame-retardant effect, the proportion of the composition in the polymeric material should not be too low. On the other hand, too much flame retardant can adversely affect the mechanical properties of the polymer.

Preferably, the weight fraction of the composition in the total weight of the polymeric material is therefore 0.5 to 30 wt. %, particularly preferably 1.0 to 20 wt. %, more preferably 2.0 to 20 wt. %, and most preferably 3 to 15 wt. %.

The polymer of the polymeric material is preferably a thermoplastic, particularly preferably an expanded and extruded polystyrene.

The composition can be introduced into the polymeric material by various methods. First of all, the composition can be incorporated into the polymer during the moulding process. If the polymer is processed by extrusion, for example, the composition can be added during the extrusion process, e.g. by means of a masterbatch. A masterbatch within the meaning of the present invention is a polymeric material, in the form of granules or powder, containing the composition and the possibly further additives in concentrations that are higher than in the final application. To produce the polymeric material, the masterbatch or different masterbatches are combined with a further polymer without the composition contained in the masterbatch in quantities or ratios that correspond to the desired concentrations of the composition in the end product. Compared to the addition of various substances in the form of pastes, powders or liquids, masterbatches have the advantage that they ensure a high level of process reliability and are very easy to process and meter. Through extrusion, the flame retardant is evenly distributed in the polymeric material.

The introduction of the composition into the polymeric material can be demonstrated by suitable analysis techniques, in particular ³¹P-NMR spectroscopy.

The present invention also relates to an aqueous solution comprising a composition according to the present invention. Preferably, the mass concentration of the composition in the aqueous solution is at least 50 g/L, preferably at least 100 g/L, more preferably at least 150 g/L, even more preferably at least 200 g/L, and most preferably at least 250 g/L.

The present invention also relates to a method for producing a composition according to the invention.

The method comprises the contacting of ammonium polyphosphate with a salt or a combination of salts selected from the group consisting of alkali metal salts and alkaline earth metal salts. This can be done in the simplest case by physically mixing ammonium polyphosphate and the salt or the combination of salts selected from the group consisting of alkali metal salts and alkaline earth metal salts, for example by diffuse or convective mixing. For example, a drum or bucket mixer can be used for this purpose. However, the contacting can also occur by dissolving or suspending the salt or the combination of salts selected from the group consisting of alkali metal salts and alkaline earth metal salts and/or ammonium polyphosphate in a solvent, preferably water, and then the solution or suspension is combined with the further components of the composition, which can also be dissolved or suspended. The solvent can then be removed by drying, preferably at a pressure of <1 bar.

Particularly preferably, the contacting occurs by adding the salt or combination of salts selected from the group consisting of alkali metal salts and alkaline earth metal salts to a reaction mixture from which the ammonium polyphosphate is formed. This allows a particularly strong interaction of alkali metal salt or alkaline earth metal salt and ammonium polyphosphate and thus pronounced effects according to the invention.

If the production of ammonium polyphosphate is carried out, for example, starting from P₂O₅ and ammonium orthophosphate in a NH3 atmosphere, the salt or combination of salts selected from the group consisting of alkali metal salts and alkaline earth metal salts can be added to the reaction mixture of P₂O₅ and ammonium orthophosphate.

The present invention also relates to the use of a salt or combination of salts selected from the group consisting of alkali metal salts and alkaline earth metal salts, preferably selected from alkali metal salts, in order to increase the transparency of ammonium polyphosphate in the visible spectral range of electromagnetic radiation and/or to decrease the decomposition temperature of ammonium polyphosphate.

The present invention also relates to the use of a composition or solution according to the invention, preferably an aqueous solution containing the composition according to the present invention, as a coating material, preferably as a coating material for wood or metal. Particularly preferred is the use for so-called natural-fibre-reinforced plastics, preferably wood-plastic composites, i.e. composite materials made of wood fibres and plastics. Because the composition according to the invention has a high transparency, it is particularly suitable for coating applications in which the structure of the coated material is to remain visible even after the coating process. Coating is understood to mean a method in accordance with DIN 8580 in which an adherent layer of formless material is applied to the surface of a workpiece.

The composition according to the invention is preferably used as a flame retardant. Here, it is preferably incorporated into the material to be protected, i.e. introduced into the material during its manufacturing or processing process. Alternatively, the composition according to the invention can be applied as a flame-retardant coating to the surface of the material. Particularly preferably, the composition according to the invention is applied to the surface of wood (wood-coating).

Particularly preferably, the composition according to the invention is used for the flame retarding of plastics, in particular plastic composite materials such as wood-plastic composites.

### EXAMPLES

The invention will now be further explained on the basis of manufacturing examples for polymers according to the invention, as well as on the basis of examples of applications according to the invention in plastic matrices and the attached figures.

Measurement Methods

Particle Size Determination Median

The particle size distributions were determined using a Horiba Partica LA-950V (Horiba, Ltd.; Kyoto; Japan) by static light scattering according to DIN/ISO 13320. For this purpose, a sample of the produced product is introduced into a dry measuring channel, and the sample is wet-measured in a measuring range of 0.01 μm to 3,000 μm.

L*a*b* Values

The L*a*b* values were determined using an UltraScan VIS-2 spectrophotometer equipped with the UltraScanVIS sensor from the HunterLab company. For this purpose, the samples were filled into a glass cuvette, and a homogeneous surface was produced on the cuvette side towards the measurement opening by tapping the cuvette or compressing the sample. The associated Easy Match QC 4.64 software uses the settings “USVIS 1145” sensor and “RSIN Mode” and calculates the L*a*b* values.

The method is carried out according to the currently valid version of EN ISO 11664-4.

Determination of Decomposition Temperature

The decomposition temperature was determined by thermogravimetric analysis. A device from the Netzsch company (STA 409 PC/PG) was used for this purpose. Typically, the decomposition temperature is given as the temperature at which a 2% weight loss occurs. For the determination, a respective amount of 10 mg of a flame retardant was filled into a crucible and heated to temperatures above 350° C. at an increase of 10 K/min. The gas flow N₂ was 30 ml/min. During heating, the weight change of the sample was measured.

Starting Materials:

| Name | Manufacturer | Purity/Mₙ | CAS |
|---|---|---|---|
| Ammonium polyphosphate | Chemische Fabrik | | 68333-79-9 |
| (APP) FR-Cross 484 | Budenheim | | |
| Sodium tetrapolyphosphate | Chemische Fabrik | | 68915-31-1 |
| Budit 9 | Budenheim | | |
| Sodium trimetaphosphate | Chemische Fabrik | | 7785-84-4 |
| N16-01 | Budenheim | | |
| Disodium isophthalate | TCI Deutschland | | 10027-33-5 |
| | GmbH | | |
| Disodium terephthalate | Alfa Aesar | >99% | 10028-70-3 |
| Sodium carbon at | VAR Chemicals | >99.5% | 497-19-8 |
| Disodium citrate | Acros Organics | >99% | 6132-05-4 |
| Sodium oxalate | Thermo Fischer | 99.5+% | 62-76-0 |
| | GmbH | | |
| Aerodur DS 3530 Acrylic | BASF SE | | |
| Binder | | | |
| Sodium sulphate | VWR Chemicals | >98% | 7757-82-6 |

### Example 1: Solubility as a Function of the Weight Ratio

In a first set of experiments, Budit 9 was added to a suspension of APP in distilled water. The mass concentration of summed masses of APP and Budit 9 in the suspension was always 50 g/L. The weight ratios of APP to Budit 9 can be found in the table below. The temperature of the suspension at and after addition of Budit 9 was 80° C. The solubility was evaluated according to optical criteria. The dissolution durations are shown in the table below.

| | | Duration of |
|---|---|---|
| APP | Budit 9 | dissolution |
| [wt. %] | [wt. %] | [s] |
| 97.5 | 2.5 | >10000^{[1]} |
| 95 | 5 | 1439 |
| 90 | 10 | 260 |
| 85 | 15 | 245 |
| 80 | 20 | 284 |
| 70 | 30 | 236 |
| 60 | 40 | 277 |
| 50 | 50 | 264 |
| | | Duration of |
| APP | N16-01 | dissolution |
| [wt. %] | [wt. %] | [s] |
| 97.5 | 2.5 | >10000 |
| 95 | 5 | 2206 |
| 90 | 10 | 1370 |
| 85 | 15 | 468 |
| 80 | 20 | 508 |
| 70 | 30 | 493 |
| 60 | 40 | 447 |
| 50 | 50 | 421 |

^{[1]}not dissolved within 10000 s

^{[1]} not dissolved within 10000 s

### Example 2: Solubility Tests with Alternative Alkali Metal Salts and Alkaline Earth Metal Salts

The experiments with alternative alkali metal salts or alkaline earth metal salts were performed analogously to Example 1, wherein the weight ratio of alkali metal salt and alkaline earth metal salt to ammonium polyphosphate was 83.3 wt. % to 16.7 wt. %. The dissolution durations are shown in the table below.

| | Duration of |
|---|---|
| Alkali metal salt and | dissolution |
| alkaline earth metal salt | [s] |
| Disodium isophthalate | 972 |
| Disodium terephthalate | 206 |
| Sodium carbonate | 563 |
| Disodium citrate | 356 |
| Sodium oxalate | 547 |

### Example 3: Preparation of a Flame-Retardant Coating

APP (435 g, 1.74 mmol) was mixed together with a sodium polyphosphate (65 g, 0.11 mmol) homogeneously in a kneader from the Linden company.

20 g of the mixture were added to 80 g of a commercially available binder system from the BASF company, Acrodur DS 3530, and dissolved with a dissolver DISPERMIX VFL1.5 from the OLIVER+BATLLE company while stirring and being heated to 60-80° C.

The transparent solution was then applied to a commercially available pressing chipboard using a 500 μm blade, and the plate was then dried at 80° C.

In a subsequent fire test according to the Epiradiateur standard (NF P 92-501), the desired intumescence developed, which in turn meets the desired flame retardant task of the Epiradiateur test.

### Example 4: Measurement of Transparency of a Coating According to the Invention

In order to demonstrate the transparency of the compositions according to the invention, a coating according to Example 3 was applied as a coating by means of a 500 μm blade on a white and a black substrate, respectively. In so doing, the L*a*b values were determined per substrate for two samples each with coating (tests 1 and 2, marked with “+” in the following tables) and for two control samples each without coating (tests 3 and 4, marked with “−”).

As can be seen in the following tables, coatings with the compositions according to the invention only lead to negligible changes in the values in the L*a*b colour space, i.e. it can inferred that the coatings have a high transparency and do not, or only insignificantly, influence the appearance of the substrate. The compositions according to the invention are thus particularly suitable for use in transparent coatings.

Black Substrate

| # | Coating | L* | a* | b* |
|---|---|---|---|---|
| 1 | + | 25.4 | −2.7 | 1.8 |
| 2 | + | 20.5 | −2.3 | 2.3 |
| 3 | − | 8.4 | −0.2 | −1.2 |
| 4 | − | 8.3 | −0.4 | −1.3 |

White Substrate

| # | Coating | L* | a* | b* |
|---|---|---|---|---|
| 1 | + | 88.7 | −0.9 | 3.8 |
| 2 | + | 89.8 | −0.8 | 3.2 |
| 3 | − | 92.0 | −1.2 | 1.8 |
| 4 | − | 91.1 | −0.8 | 1.6 |

### Example 5: Measurement of the Decomposition Temperature of a Composition According to the Invention

### Example 5a

APP (435 g, 1.74 mmol) was mixed together with a sodium polyphosphate (55 g, 0.09 mmol) homogeneously in a kneader from the Linden company and the decomposition temperature determined. This was 146.4° C.

### Example 5b

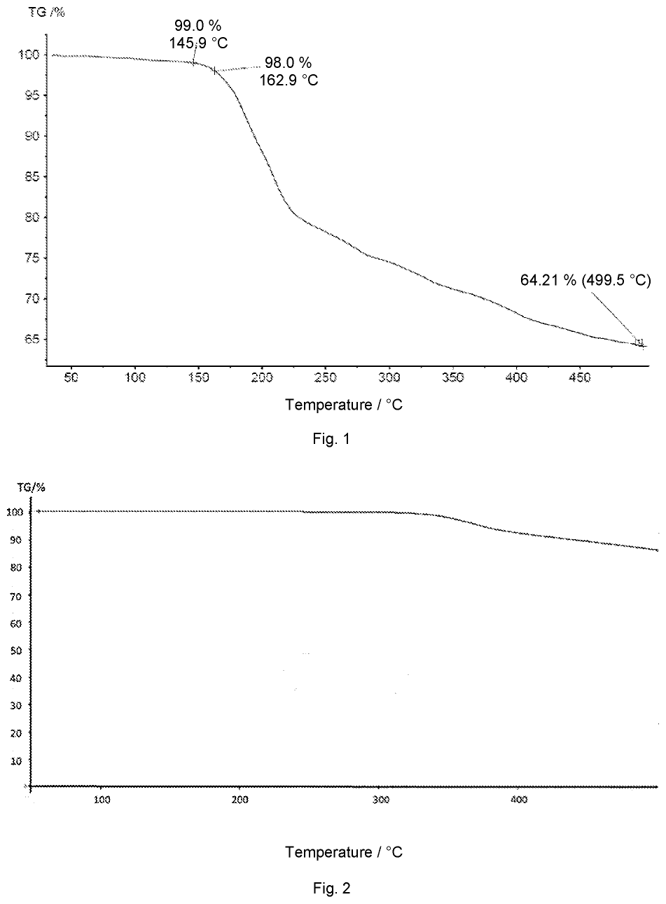

Diammonium phosphate (70.0 g) was heated together with urea (45.0 g) and CaCO₃ (6.2 g) to 130° C. and homogeneously mixed for 2.5 hrs in a kneader from the Linden company. Subsequently, Budit 9 (3.5 g) was added and mixed for a further 1.5 hrs. After cooling, the mass is pulverized and dried. The decomposition temperature (2% loss of mass) was 162.9° C. (FIG. 1), whereas that of pure APP (FR Cross 484) was 347.1° C. (FIG. 2).

1: A composition comprising
A) ammonium polyphosphate, and
B) a salt or combination of salts selected from the group consisting of alkali metal salts and alkaline earth metal salts,
wherein
the weight ratio of A) to B) in the composition is in the range of 20:1 to 1:1.

2: The composition according to claim 1, wherein the alkali metal salts and alkaline earth metal salts are selected from among phosphates, preferably among oligo-, meta-, pyro-, and polyphosphates.

3: The composition according to claim 2, wherein the alkali metal salts and alkaline earth metal salts are selected from among oligo- and polyphosphates, and wherein the number-average degree of polymerization of the oligo- or polyphosphates is at least 2, but not more than 200.

4: The composition according to claim 1, wherein the alkali metal salts and alkaline earth metal salts are organic alkali metal salts and alkaline earth metal salts, preferably selected from the class of compounds consisting of carbonates, oxalates, terephthalates, isophthalates, formates, fumarates, tartrates, maleates, phenolates, benzoates, acetates, citrates, succinates, lactates, glycolates and mixtures of the foregoing.

5: The composition according to claim 1, wherein all metal ions of the alkali metal ions or alkaline earth metal ions of the alkali metal salts and alkaline earth metal salts are Na or K.

6: The composition according to claim 1, wherein the ammonium polyphosphate has a grain size determined by light scattering in accordance with DIN ISO 13320 of ≤100 μm.

7: The composition according to claim 1, wherein the number-average degree of polymerization of the ammonium polyphosphate is >100.

8: The composition according to claim 1, wherein the composition has a halogen content and/or a content of metals having a density >5 g/cm³ of ≤1.0 wt. %.

9: The composition according to claim 1, wherein the water content of the composition determined in accordance with EN 20287 is at least 0.5 wt. %.

10: A polymeric material comprising a polymer and the composition according to claim 1, wherein the weight fraction of the composition is from 0.5 to 30 wt. % of the polymeric material.

11: An aqueous solution comprising the composition according to claim 1, wherein the mass concentration of the composition in the aqueous solution is preferably at least 50 g/L.

2: A method for preparing the composition according to claim 1, comprising the contacting of ammonium polyphosphate with a salt or a combination of salts selected from the group consisting of alkali metal salts and alkaline earth metal salts, wherein the contacting is preferably accomplished by adding the salt or combination of salts to a reaction mixture from which the ammonium polyphosphate is formed.

13: A method comprising adding to ammonium polyphosphate a salt or combination of salts selected from the group consisting of alkali metal salts and alkaline earth metal salts in order to increase the transparency of the ammonium polyphosphate in the visible spectral range of electromagnetic radiation and/or to decrease the decomposition temperature of the ammonium polyphosphate.

14: A method comprising coating material with the composition according to claim 1.

15: A flame retardant comprising the composition according to claim 1.

16: A method comprising coating material with the aqueous solution according to claim 11.
